(19) United States
(12) Patent Application Publication
(10) Pub. No.: US 2019/0173735 A1
(43) Pub. Date: Jun. 6, 2019

(54) NETWORK USER IDENTIFICATION USING TRAFFIC ANALYSIS

(71) Applicant: Chronicle LLC, Mountain View, CA (US)

(72) Inventor: Michael Wiacek, Mountain View, CA (US)

(21) Appl. No.: 15/833,386

(22) Filed: Dec. 6, 2017

(51) Int. Cl. H04L 12/24; H04L 29/08; H04L 29/12

(52) U.S. Cl. CPC H04L 41/064; H04L 67/22; H04L 61/2092; H04L 61/2015; H04L 61/1505

(57) ABSTRACT

The subject matter of this specification generally relates to computer networks. In some implementations, a method includes identifying a network address associated with a network event. Network activity (i) that was initiated by a computing device assigned the network address and (ii) that occurred within a threshold period of time of the network event is identified. A user that was assigned the network address at a time at which the network event occurred is identified using one or more network address assignment logs. A level of confidence that the user was using the network address at the time of the network event is determined based on the identified network activity and one or more patterns of network activity initiated by the user. An action is performed based on the level of confidence.

### TECHNICAL FIELD

This disclosure generally relates to computer network monitoring and security.

### BACKGROUND

Some network systems automatically provide Internet Protocol (IP) addresses and/or other network configuration data to computing devices so that each computing device has a unique IP address. For example, the Dynamic Host Configuration Protocol (DHCP) automatically assigns IP addresses to computing devices for a period of time. However, some users may bypass the DHCP protocol and manually assign IP addresses to their computing devices. Therefore, a DHCP log of IP address/physical machine assignments may not always accurately reflect the computing device that was using a particular IP address at a particular time.

### SUMMARY

This specification describes systems, methods, devices, and techniques for identifying a user associated with a network address at a particular time, e.g., at the time of a network event.

In general, one innovative aspect of the subject matter described in this specification can be implemented in a method that includes identifying a network address associated with a network event. Network activity (i) that was initiated by a computing device assigned the network address and (ii) that occurred within a threshold period of time of the network event is identified. A user that was assigned the network address at a time at which the network event occurred is identified using one or more network address assignment logs. A level of confidence that the user was using the network address at the time of the network event is determined based on the identified network activity and one or more patterns of network activity initiated by the user. An action is performed based on the level of confidence. Other embodiments of this aspect include corresponding methods, systems, apparatus, and computer programs, configured to perform the actions of the methods, encoded on computer storage devices.

These and other implementations can optionally include one or more of the following features. In some aspects, identifying the user that was assigned the network address at the time at which the network event occurred includes identifying a last user assigned the network address prior to the network event occurring.

In some aspects, identifying the user that was assigned the network address at the time at which the network event occurred includes identifying, using the one or more network address assignment logs, a device identifier for a device that was assigned the network address at the time the network event occurred and identifying, as the user that was assigned the network address at the time at which the network event occurred, a user associated with the device.

In some aspects, performing the action based on the level of confidence includes determining that the level of confidence does not meet a threshold level of confidence and in response to determining that the level of confidence does not meet the threshold level of confidence, identifying one or more additional users. For each additional user, a determination is made, based on the identified network activity and one or more patterns of network activity initiated by the additional user, a respective level of confidence that the additional user initiated the network event. A particular user for which the respective level of confidence is highest is identified from the user and the one or more additional users. Identifying one or more additional users can include identifying one or more additional users that were previously assigned the network address prior to the time at which the network event occurred.

In some aspects, performing the action based on the level of confidence includes determining that the level of confidence meets a threshold level of confidence and generating and transmitting data that identifies the user.

In some aspects, the identified network activity includes a sequence of requested domain names. Determining, based on the identified network activity and the one or more patterns of network activity initiated by the user, the level of confidence that the user initiated the network event can include identifying, as the one or more patterns of network activity initiated by the user, one or more probabilistic patterns. Each probabilistic pattern can represent a sequence of host names and, for each transition from a first host name to a second host name in the sequence of host names, a probability that the user will request the second host name after the second host name. The level of confidence can be determined using the probabilistic patterns and the identified network activity.

Particular embodiments of the subject matter described in this specification can be implemented so as to realize one or more of the following advantages. The use of network address assignment logs in combination with users' patterns of network activity allows for more accurate identification of a user (or computing device) that was using a particular network address at a particular time. Accurately identifying the user (or computing device) that was using a particular network address (e.g., IP address) at a particular time allows a network management system to more quickly respond to and mitigate network security events. For example, by knowing which computing device was using a particular IP address from which a virus was introduced to the network, the network management system can quickly isolate the computing device and prevent the virus from spreading across the network. Using patterns of network activity also allows for a quicker determination of the computing device from which a network event originated without having to perform complex analysis on computing devices, network devices, and/or files stored on the computing devices, to identify the source of the event. This allows the system to use fewer computer resources (e.g., CPU cycles used for analysis, memory used to store results of the analysis, network resources used to obtain data from multiple computers, etc.) to identify the computing device from which the network event originated than performing the more complex analysis especially for large corporate networks with many computing devices.

Various features and advantages of the foregoing subject matter is described below with respect to the figures. Additional features and advantages are apparent from the subject matter described herein and the claims.

### DESCRIPTION OF DRAWINGS

FIG. 1 depicts an example environment in which a network management system identifies users associated with network addresses.

FIG. 2 depicts a flowchart of an example process for performing an action based on a level of confidence that a user initiated a network event.

FIG. 3 depicts a flowchart of an example process for identifying a user that initiated a network event and transmitting data that identifies the user.

Like reference numbers and designations in the various drawings indicate like elements.

### DETAILED DESCRIPTION

In general, this disclosure describes systems, methods, devices, and techniques for identifying a user associated with (e.g., that was using) a network address at a particular time, e.g., at the time of a network event. A network server (e.g., a DHCP server) can assign network addresses (e.g., IP addresses) to computing devices for a specified period of time. When an IP address is assigned to a computing device, the IP address and a device identifier for the computing device can be stored in a network address assignment log (e.g., in a DCHP log) along with a time at which the IP address was assigned to the computing device. The network address assignment log can also include an expiration time that indicates when use of the IP address by the computing device is supposed to end.

A network management system can use the network assignment log to determine which computing device was supposed to be assigned the particular IP address at a particular time, e.g., at the time of a network event. However, a computing device (or its user) that was previously assigned the IP address can ignore the expiration time of the IP address assignment and continue to use the IP address. In addition, users may bypass DHCP (or other IP address assignment techniques) and manually assign an IP address to a computing device. Thus, using network assignment logs alone may not always be accurate in identifying a user of an IP address at a particular time.

The network management system can use the network address assignment logs in combination with network activity (e.g., network traffic patterns) of users to determine which user was using a particular network address at a particular time. For example, when a network event is detected, the network management system can identify a network address associated with the network event and use the network address assignment logs to identify the computing device that was supposed to be assigned the network address at the time of the network event. The network management system can then identify a user of the computing device, e.g., using a log of users and their associated computing device(s).

The network management system can obtain patterns of network activity initiated by the user. The patterns can include sequences of host names (e.g., domain names) of resources that were requested by the user, the number of network requests initiated by the user (e.g., an average number of requests over one or more time periods), and/or other appropriate patterns of network activity. The network management system can compare the user's patterns of network activity to network activity associated with the network address around the time of the network event to determine a level of confidence that the user initiated the network event. For example, users may often visit the same web sites in the same sequence or in similar sequences. If the computing device associated with the network event requested resources from the same web sites as the user, the level of confidence that the user initiated the network event may be high. If the computing device associated with the network event requested web sites that the user does not visit, or visits rarely, the level of confidence that the user initiated the network event may be low.

If the level of confidence is low (e.g., less than a threshold), the network management system can identify other users, e.g., other users that were assigned the network address from which the network event was initiated. The network management system can then compare the network activity associated with the network address around the time of the network event to patterns of network activity of the other users to determine which user initiated the network event.

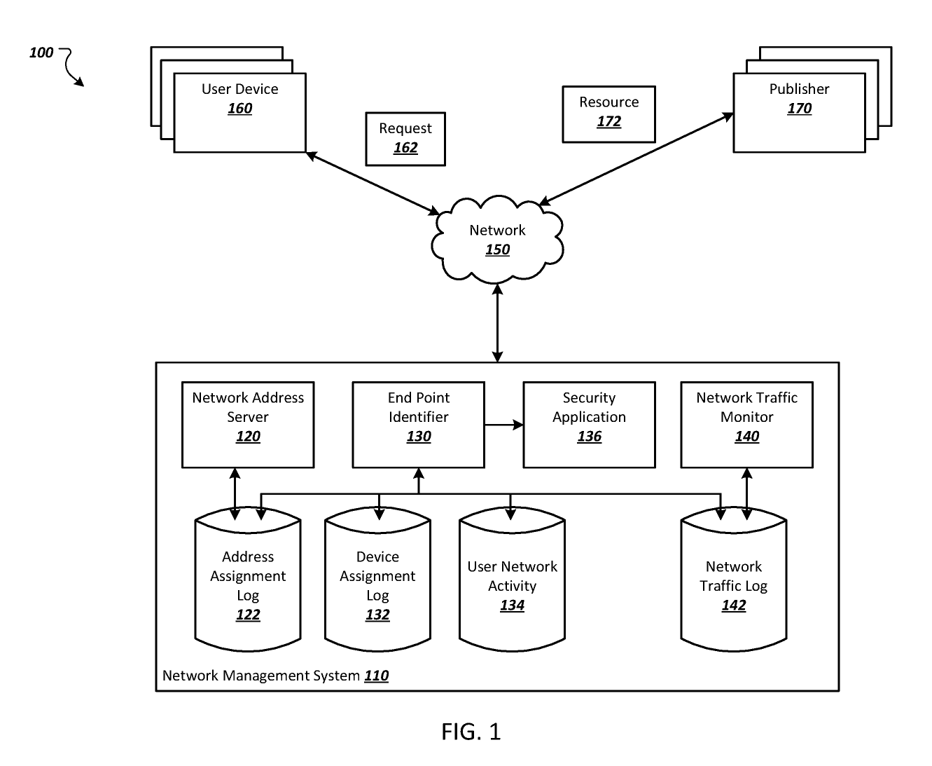

FIG. 1 depicts an example environment 100 in which a network management system 110 identifies users associated with network addresses. The example network management system 110 can facilitate network communications for user devices 160 over a data communication network 150. For example, as described in more detail below, the network management system 110 can assign network addresses to the user devices 160, forward network requests 162 (e.g., requests for electronic resources such as web pages) to resource publishers 170, and/or provide the electronic resources 172 to the user devices 160. The user devices 160 can be computing devices, such as laptop computers, desktop computers, tablet computers, smartphones, wearable devices, gaming consoles, smart televisions, or other appropriate devices.

The data communication network 150 can include a local area network (LAN), a wide area network (WAN), a mobile network, the Internet, or a combination thereof. In some implementations, the user devices 160 communicate with the network management system 110 over a LAN or WAN and the network management system 110 communicates with computing devices of the publishers 170 over the Internet. For example, the network management system 110 may be part of an organization's network that facilitates internal network communications within an intranet and external network communications over the Internet. In some implementations, the user devices 160, the network management system 110, and the computing devices of the publishers 170 communicate over the Internet.

The network management system 110 includes a network address server 120, which can include one or more computers that assign network addresses to user devices 160. The network address server 120 can assign a network address to user devices 160 that would like to communicate over the network 150. In some implementations, the network address server 120 is a DHCP server that assigns IP addresses to user devices 160. For example, the network address server 120 can assign an IP address to a user device 160 for a specified period of time. At the end of the specified period of time, the network address server 120 can assign the IP address to another user device.

The network address server 120 can also maintain a network address assignment log 122 stored in computer-readable storage media, e.g., one or more hard drives, flash memory, etc. The network address assignment log 122 can store data related to network address assignments made by the network address server 120. In some implementations, the network address assignment log 122 includes, for each network address assignment made by the network address assignment log, a device identifier for the user device 160 that was assigned the network address, the network address assigned to the user device 160, a time at which the network address was assigned to the user device 160, and an expiration time for the network address assignment. The expiration time for a network address assignment is a time at which the user device is supposed to stop using the network address. The device identifier for the user device 160 can include a media access control (MAC) address for the user device 160.

As an example, if the network address server 120 assigns an IP address to a computer, the network address server 120 can record, in the address assignment log 122, the MAC address for the computer, the IP address assigned to the computer, the time at which the computer was assigned the IP address, and the expiration time for the IP address assignment. The computer can then use the IP address for network communications over the network until the expiration time is reached. However, as described above, some computing devices (or their users) may ignore the expiration time and continue using the IP address or otherwise use IP addresses different from the ones indicated by the address assignment log 122.

The network management system 110 also includes a device assignment log 132 stored in computer-readable storage media e.g., one or more hard drives, flash memory, etc. The device assignment log 132 can store data related to user devices 160 assigned to or otherwise used by users. In some implementations, the device assignment log 132 can include, for each user device 160, a device identifier (e.g., MAC address) for the user device 160 and one or more user identifiers for one or more users that are assigned to or use the user device 160. The device assignment log 132 can also include, for each user of a particular user device, one or more time periods that the user has been assigned to the particular user device or one or more time periods that the user has access to the particular user device. For example, some employees may share computing devices over different shifts.

The network management system 110 also includes a network traffic monitor 140, which can be implemented as an application that is executed by one or more computers. The network traffic monitor 140 can log data related to network traffic in a network traffic log 142 that is stored in computer-readable storage media e.g., one or more hard drives, flash memory, etc. In some implementations, the network traffic monitor 140 is a Domain Name Server (DNS) logger that logs host names (e.g., domain names) of network resources requested by the user devices 160. When a user device 160 requests a resource from a particular domain, the network traffic monitor 140 can receive the request (or data of the request) and log data related to the request in the network traffic log 142. The data can include, for each request, a network address from which the request was initiated, the domain name of the requested domain, and a time at which the request was received. For example, if a user device 160 with IP address 198.12.3 requested a web page “www.example.com/examplenewspage” at 1:00 PM, the network traffic log can include an entry that includes the IP address, the domain “example.com” and 1:00 PM.

The network management system 110 also includes an end point identifier 130 that identifies a user that was associated with (e.g., that was using) a network address at a particular time. The end point identifier 130 can implemented using one or more computers, e.g., as an application that is executed by the one or more computers. In some implementations, the end point identifier 130 uses the address assignment log 122, the device assignment log 132, and the network traffic log 142 to identify which user was assigned a network address and determine a level of confidence that the user was using the network address at a particular time, e.g., at the time of a network event that originated from a computing device using the network address.

The end point identifier 130 can use the address assignment log 122 to identify a user device that was assigned a particular network address at a particular time. For example, the end point identifier 130 can find, in the network address assignment log 122, an entry for the particular network address that has a start time (e.g., the time at which the particular network address was assigned to a user device) that was prior to the particular time and an expiration time that was after the particular time. In another example, the end point identifier 130 can identify the last user device assigned the network address prior to the particular time. The end point identifier 130 can obtain, from the address assignment log 122, the device identifier for the identified user device.

The end point identifier 130 can use the device assignment log 132 to identify the user of the identified user device. For example, the end point identifier 130 can identify an entry for the identified device identifier in the device assignment log 132. The end point identifier 130 can then obtain, from the entry, the user identifier for each user that is assigned to or that uses the identified user device. If multiple users are assigned to or use the identifier user device, the end point identifier 130 can obtain the user identifier for each of the multiple users or obtain the user identifier for the user that was assigned the identified user device at the particular time.

The end point identifier 130 can determine a level of confidence that the identified user was using the identified user device at the particular time based on network activity of the identified user and network activity associated with the particular network address around the particular time. The network activity associated with the particular network address can include network activity associated with the particular network address that occurred within a threshold period of time (e.g., one minute, ten minutes, one hour, or some other appropriate time period) before the particular time and/or network activity that occurred within a threshold period of time (e.g., one minute, ten minutes, one hour, or some other appropriate time period) after the particular time. For example, the network activity associated with the particular network address can include network activity that occurred within a time window including time before the particular time and/or time after the particular time.

The network activity associated with the particular network address can include network requests made by a user device using the particular network address within the time window. For example, the end point identifier 130 can obtain, from the network traffic log 142, data entries that include the particular network address and that have an associated time that is within the time window. This data can include host names of resources requested by the particular network address, the times at which the host names were requested, and/or other appropriate data included in network traffic logs such as DNS logs.

The network activity of the identified user can include similar information as the network activity associated with the particular network address. For example, the network activity of the identified user can include host names of resources requested by the identified user. The network activity of the identified user can also include a number of network requests initiated by the user. In some implementations, the network activity of the identified user can include an average number of requests initiated by the user for each of one or more time periods. For example, the network activity of the identified user can include the average number of requests initiated by the user for each hour of the day and each average can be determined over multiple days.

The end point identifier 130 can maintain network activity data for each user in a user network activity data storage unit 134. For example, the end point identifier 130 can aggregate data for each user from the network traffic log 142 and maintain the aggregated data in the user network activity data storage unit 134. The end point identifier 130 can update the data for users, e.g., periodically based on a specified time period or in response to new network traffic.

In some implementations, the end point identifier 130 may only aggregate network activity data for a user if the user is logged into a computing device that initiated the network activity. In some implementations, the end point identifier 130 may match network activity to a user based on a sequence of domains requested in the network activity and previous network activity of the user. For example, if the user has been assigned an IP address from which the network activity occurred and the network activity is similar to previous network activity of the user, the network activity may be associated with the user. If the network activity matches multiple users that have been assigned the IP address, the network activity may be associated with the user to which the network activity is most similar.

In some implementations, the end point identifier 130 generates patterns of network activity for each user and stores the patterns in the user network activity data storage unit 134. Each pattern of network activity for a user can include a sequence of host names of resources requested by the user. For example, each pattern of network activity for a user can represent a sequence of host names of resources requested by the user at some point of time in the past. As many users visit web sites in the same or a similar order over time, each pattern of network activity can have an associated probability of occurrence based on the number of times the user requested the host names in the same sequence as the pattern. For example, the probability of occurrence for a pattern of network activity can be equal to, or directly proportional to, the number of times the user requested the host names in the same sequence as the pattern of network activity divided by the total number of different patterns of network activity for the user.

In some implementations, each pattern of network activity for a user is a probabilistic representation for a sequence of host names. A probabilistic representation can include a sequence of host names and, for each transition from one host name to another host name, a probability that the user will navigate from the one host name to the other host name. Each probability can be based on the number of times the user actually navigated from the one host name to the other host name. An example of a probabilistic representation is Domain A→(80%) Domain B→(40%) Domain C. In this example, when the user navigated from Domain A to another domain, the other domain was Domain B 80% of the time. Similarly, when the user navigated from Domain B to another domain, the other domain was Domain C 40% of the time.

To determine the level of confidence that the identified user was using the identified user device at the particular time, the end point identifier 130 can compare the network activity of the identified user to the network activity associated with the particular network address within the time window around the particular time. The level of confidence can be based on the number of matching host names between the network activity of the identified user to the network activity associated with the particular network address. For example, a higher number of matching host names may result in a higher level of confidence and a lower number of matching host names may result in a lower level of confidence.

The level of confidence can be based on an average number of network requests made by the identified user around the particular time (e.g., within the time window) and the number of network requests made by the particular IP address within the time window. A larger difference between the average number of requests made by the identified user and the number of network requests made by the particular IP address within the time window can result in a lower level of confidence. Similarly, a smaller difference between the average number of requests made by the identified user and the number of network requests made by the particular network address within the time window can result in a higher level of confidence.

The level of confidence can be based on a comparison of a sequence of host names of resources that were requested by the particular network address during the time window around the particular time to patterns of network activity for the identified user. For example, if the sequence of host names of resources were requested by the particular network address include transitions between host names that match transitions in the user's patterns that have higher probabilities (e.g., greater than a threshold probability), the level of confidence may be higher than if the transitions of the particular network address do not match the user's patterns or matches lower probability transitions. In a particular example, the level of confidence can be equal to, or directly proportional to, a sum of the probabilities for each transition between host names in the user's patterns of network activity that match a transition between host names in the sequence of host names of resources that were requested by the particular network address. In some implementations, informational retrieval techniques, such as K-means clustering and cosine similarity, using the sequence of host names requested by the particular network address and network activity of the identified user can be used to determine the level of confidence.

In some implementations, the end point identifier 130 uses machine learning techniques to determine the level of confidence that the identified user was using the identified user device at the particular time. For example, the end point identifier 130 can train one or more machine learning models using labeled training data to determine a level of confidence using, as inputs to the model, network activity of the identified user (e.g., the patterns of network activity) and network activity of the particular network address during the time window.

If the level of confidence determined for the identified user is high (e.g., meets or exceeds a threshold), it is likely that the identified user was using the particular network address at the particular time. If not, another user may have been using the particular network address at that time. For example, another user may have manually set the network address of the user's device to the particular network address that was assigned to the identified user.

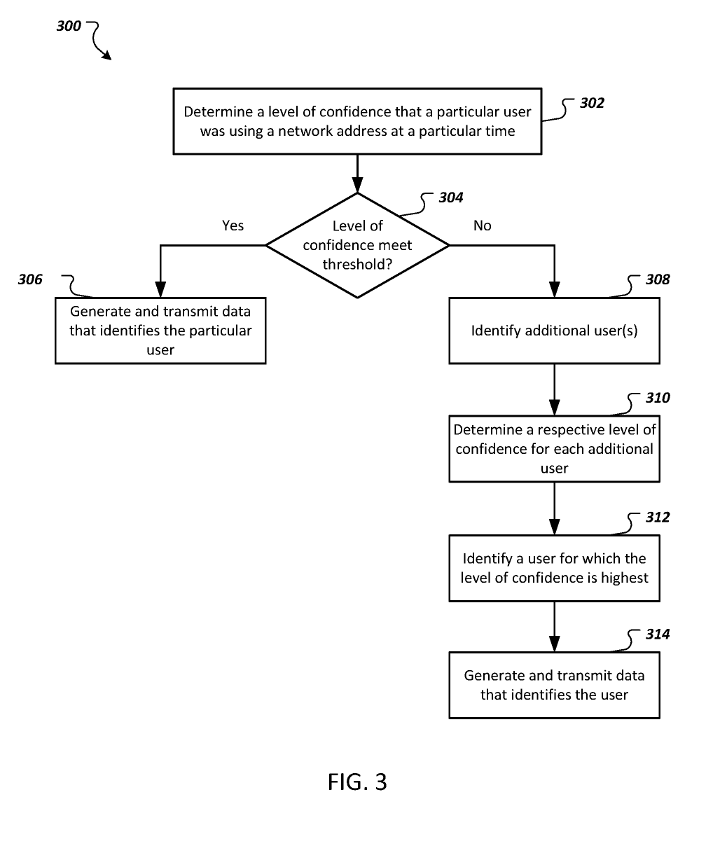

The end point identifier 130 can perform an action based on the level of confidence. If the level of confidence meets or exceeds a threshold, the end point identifier 130 may generate and transmit data that indicates that the identified user was using the particular network address at the particular time and optionally the determined level of confidence. For example, if the level of confidence was determined in response to a network security event being detected, the end point identifier 130 can transmit the data to a security application 136. The security application 136 can perform an action based on the information in the transmitted data. For example, the security application 136 can isolate the user device(s) of the identified user from the network 150 or attempt to mitigate the network event another way. If the level of confidence does not meet the threshold, the end point identifier 130 can evaluate the network activity of other users to determine which user was using the particular network address at the particular time, as described in more detail below with reference to FIG. 3.

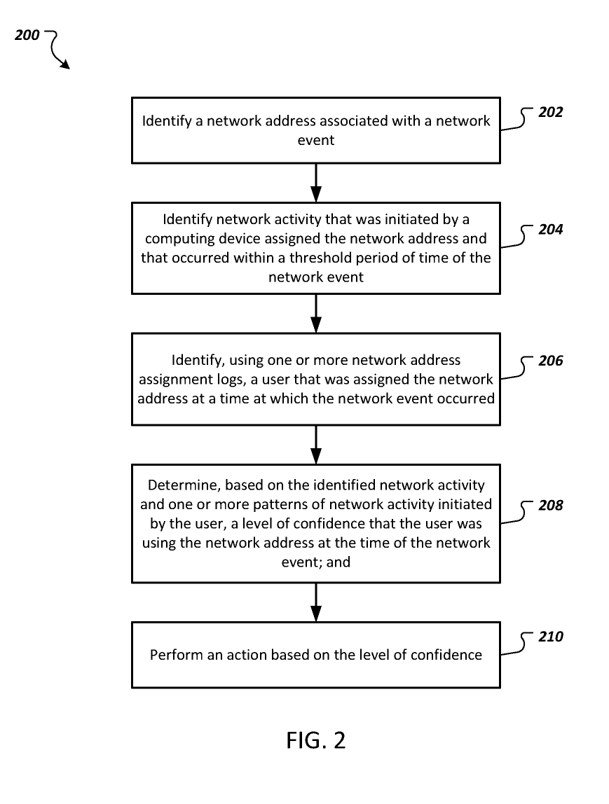

FIG. 2 depicts a flowchart of an example process 200 for performing an action based on a level of confidence that a user initiated a network event. Operations of the process 200 can be implemented, for example, by a system that includes one or more data processing apparatus, such as the network management system 110 of FIG. 1. The process 200 can also be implemented by instructions stored on a computer storage medium where execution of the instructions by a system that includes a data processing apparatus cause the data processing apparatus to perform the operations of the process 200.

The system identifies a network address associated with a network event (202). For example, the system may identify an IP address of a computing device that initiated a network event. The network event can be downloading a resource (e.g., web page) that includes a detected virus or other malicious software, that requested a resource from blacklisted web site (e.g., a site known to be malicious), the identification of malicious software on the computing device, or another appropriate network event.

The system identifies network activity that (i) was initiated by a computing device assigned the network address and (ii) occurred within a threshold period of time of the network event (204). The threshold period of time can include a period of time before the time of the network event and/or a period of time after the time of the network event. For example, the threshold period of time may be fifteen minutes before the time of the network event and fifteen minutes after the network event. In this example, the network activity would include network activity initiated by the computing device within a thirty-minute window that started fifteen minutes before the time of the network event and ended fifteen minutes after the time of the network event. The network activity can include, for example, data specifying host names of resources requested by the computing device and the times at which each request was made. The system can obtain the data from a network traffic log, e.g., the network traffic log 142 of FIG. 1.

The system identifies, using one or more network traffic logs, a user that was assigned the network address at the time at which the network event occurred (206). For example, the system can use an address assignment log, such as the address assignment log 122 of FIG. 1, to identify a device identifier that was assigned the identified network address at the time of the network event. The system can find, in the network address assignment log, an entry for the identified network address that has a start time (e.g., the time at which the network address was assigned to a user device) that was prior to the time of the network event and an expiration time that was after the time of the network event. In another example, the system can identify the last user device assigned the network address prior to the time of the network event. The system can obtain, from the address assignment log, the device identifier for the identified user device. The system can then identify an entry for the identified device identifier in a device assignment log and obtain, from the entry, the user identifier for the user of the device identified by the device identifier.

The system determines a level of confidence that the user was using the network address at the time of the network event (208). The system can determine the level of confidence based on the identified network activity for the network address and one or more patterns of network activity initiated by the identified user. For example, as described above, the system can determine the level of confidence based on a comparison of the identified network activity for the network address and one or more patterns of network activity initiated by the identified user, using machine learning techniques, and/or based on a comparison of a sequence of host names of resources were requested by the network address to patterns of network activity for the identified user.

The system performs an action based on the determined level of confidence (210). For example, the system can compare the level of confidence to a threshold. If the level of confidence meets or exceeds the threshold, the system can determine that it is likely that the user was using the network address at the time of the network event. The system can also generate and transmit data that identifies the user and optionally the level of confidence and the network event itself. For example, the system may transmit the data to a network security system that performs one or more actions based on the network event.

If the level of confidence does not meet the threshold, the system can identify other users and determine a respective level of confidence for each other user. The system can then determine, based on the levels of confidence which user was most likely to have been using the network address at the time of the network event. The system can then generate and send data that identifies this user, e.g., to a network security system.

FIG. 3 depicts a flowchart of an example process 300 for identifying a user that initiated a network event and transmitting data that identifies the user. The process 300 can also be implemented by instructions stored on a computer storage medium where execution of the instructions by a system that includes a data processing apparatus cause the data processing apparatus to perform the operations of the process 300.

The system determines a level of confidence that a particular user was using a network address at a particular time (302). For example, as described above, the level of confidence can be determined based on network activity associated with the network address within a time window that includes the particular time and network activity of the particular user.

The system determines whether the level of confidence meets a threshold (304). The threshold can be a specified value that represents a minimum level of confidence for positively identifying a user as the user that was using a network address.

If the level of confidence meets or exceeds the threshold, the system generates and transmits data that identifies the particular user (306). The data can also specify the determined level of confidence. For example, the system can transmit the data to a network security system so that the network security system can take action based on the data.

If the level of confidence does not meet the threshold, the system identifies one or more additional users (308). For example, the system can identify additional users that were assigned the network address prior to the particular time, i.e., because the computing device of these users may be likely to attempt to use the network address again at a later time. The system can identify users that were assigned the network address within a period of time (e.g., one day, one week, or another appropriate time period) prior to the particular time, i.e., because computing devices that were more recently assigned the network address may be more likely to attempt to attempt to use the network address at a later time.

In another example, the system can identify all users that were assigned the network address at some time prior to the particular time. In yet another example, the system can identify all users within an organization.

The system determines a respective level of confidence for each additional user as described above with reference to FIGS. 1 and 2 (310). The respective level of confidence for each additional user represents that level of confidence that the user was using the network address at the particular time and can be determined based on network activity associated with the network address within the time window that includes the particular time and network activity of the additional user.

The system identifies a user for which the level of confidence is highest among the particular user and the one or more additional users (312). The system can then generate and transmit data that identifies the user having the highest level of confidence, e.g., to a network security system (314).

In some implementations, the system only generates and transmits the data if the highest level of confidence meets or exceeds the threshold. For example, the network activity may not be a positive match for any of the users.

In some implementations, the system can expand the number of users and determine levels of confidence for the expanded set of users until the system identifies a user for which the respective level of confidence meets or exceeds the threshold. The system can first expand the number of users from those that were assigned the network address within the period of time to all users that were previously assigned the network address if none of the levels of confidence for the users that were assigned the network address within the period time meets or exceeds the threshold. If none of the users that were previously assigned the network address at some point in the past have a level of confidence that meets or exceeds the threshold, the system can expand the set of users again to include all users in the organization or all users for which the system has stored network activity.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
identifying a network address associated with a network event;
identifying network activity (i) that was initiated by a computing device assigned the network address and (ii) that occurred within a threshold period of time of the network event;
identifying, using one or more network address assignment logs, a user that was assigned the network address at a time at which the network event occurred;
determining, based on the identified network activity and one or more patterns of network activity initiated by the user, a level of confidence that the user was using the network address at the time of the network event; and
performing an action based on the level of confidence.

2. The method of claim 1, wherein identifying the user that was assigned the network address at the time at which the network event occurred comprises identifying a last user assigned the network address prior to the network event occurring.

3. The method of claim 1, wherein identifying the user that was assigned the network address at the time at which the network event occurred comprises:
identifying, using the one or more network address assignment logs, a device identifier for a device that was assigned the network address at the time the network event occurred; and
identifying, as the user that was assigned the network address at the time at which the network event occurred, a user associated with the device.

4. The method of claim 1, wherein performing the action based on the level of confidence comprises:
determining that the level of confidence does not meet a threshold level of confidence; and
in response to determining that the level of confidence does not meet the threshold level of confidence:
identifying one or more additional users;
for each additional user, determining, based on the identified network activity and one or more patterns of network activity initiated by the additional user, a respective level of confidence that the additional user initiated the network event; and
identifying, from the user and the one or more additional users, a particular user for which the respective level of confidence is highest.

5. The method of claim 4, wherein identifying one or more additional users comprises identifying one or more additional users that were previously assigned the network address prior to the time at which the network event occurred.

6. The method of claim 1, wherein performing the action based on the level of confidence comprises:
determining that the level of confidence meets a threshold level of confidence; and
generating and transmitting data that identifies the user.

7. The method of claim 1, wherein:
the identified network activity includes a sequence of requested domain names; and
determining, based on the identified network activity and the one or more patterns of network activity initiated by the user, the level of confidence that the user initiated the network event comprises:
identifying, as the one or more patterns of network activity initiated by the user, one or more probabilistic patterns, each probabilistic pattern representing a sequence of host names and, for each transition from a first host name to a second host name in the sequence of host names, a probability that the user will request the second host name after the second host name; and
determining the level of confidence using the probabilistic patterns and the identified network activity.

8. A system, comprising:
a data processing apparatus; and
a computer storage medium encoded with a computer program, the program comprising data processing apparatus instructions that when executed by the data processing apparatus cause the data processing apparatus to perform operations comprising:
identifying a network address associated with a network event;
identifying network activity (i) that was initiated by a computing device assigned the network address and (ii) that occurred within a threshold period of time of the network event;
identifying, using one or more network address assignment logs, a user that was assigned the network address at a time at which the network event occurred;
determining, based on the identified network activity and one or more patterns of network activity initiated by the user, a level of confidence that the user was using the network address at the time of the network event; and
performing an action based on the level of confidence.

9. The system of claim 8, wherein identifying the user that was assigned the network address at the time at which the network event occurred comprises identifying a last user assigned the network address prior to the network event occurring.

10. The system of claim 8, wherein identifying the user that was assigned the network address at the time at which the network event occurred comprises:
identifying, using the one or more network address assignment logs, a device identifier for a device that was assigned the network address at the time the network event occurred; and
identifying, as the user that was assigned the network address at the time at which the network event occurred, a user associated with the device.

11. The system of claim 8, wherein performing the action based on the level of confidence comprises:
determining that the level of confidence does not meet a threshold level of confidence; and
in response to determining that the level of confidence does not meet the threshold level of confidence:
identifying one or more additional users;
for each additional user, determining, based on the identified network activity and one or more patterns of network activity initiated by the additional user, a respective level of confidence that the additional user initiated the network event; and
identifying, from the user and the one or more additional users, a particular user for which the respective level of confidence is highest.

12. The system of claim 11, wherein identifying one or more additional users comprises identifying one or more additional users that were previously assigned the network address prior to the time at which the network event occurred.

13. The system of claim 8, wherein performing the action based on the level of confidence comprises:
determining that the level of confidence meets a threshold level of confidence; and
generating and transmitting data that identifies the user.

14. The system of claim 8, wherein:
the identified network activity includes a sequence of requested domain names; and
determining, based on the identified network activity and the one or more patterns of network activity initiated by the user, the level of confidence that the user initiated the network event comprises:
identifying, as the one or more patterns of network activity initiated by the user, one or more probabilistic patterns, each probabilistic pattern representing a sequence of host names and, for each transition from a first host name to a second host name in the sequence of host names, a probability that the user will request the second host name after the second host name; and
determining the level of confidence using the probabilistic patterns and the identified network activity.

15. A non-transitory computer storage medium encoded with a computer program, the program comprising instructions that when executed by one or more data processing apparatus cause the data processing apparatus to perform operations comprising:
identifying a network address associated with a network event;
identifying network activity (i) that was initiated by a computing device assigned the network address and (ii) that occurred within a threshold period of time of the network event;
identifying, using one or more network address assignment logs, a user that was assigned the network address at a time at which the network event occurred;
determining, based on the identified network activity and one or more patterns of network activity initiated by the user, a level of confidence that the user was using the network address at the time of the network event; and
performing an action based on the level of confidence.

16. The non-transitory computer storage medium of claim 15, wherein identifying the user that was assigned the network address at the time at which the network event occurred comprises identifying a last user assigned the network address prior to the network event occurring.

17. The non-transitory computer storage medium of claim 15, wherein identifying the user that was assigned the network address at the time at which the network event occurred comprises:
identifying, using the one or more network address assignment logs, a device identifier for a device that was assigned the network address at the time the network event occurred; and
identifying, as the user that was assigned the network address at the time at which the network event occurred, a user associated with the device.

18. The non-transitory computer storage medium of claim 15, wherein performing the action based on the level of confidence comprises:
determining that the level of confidence does not meet a threshold level of confidence; and
in response to determining that the level of confidence does not meet the threshold level of confidence:
identifying one or more additional users;
for each additional user, determining, based on the identified network activity and one or more patterns of network activity initiated by the additional user, a respective level of confidence that the additional user initiated the network event; and
identifying, from the user and the one or more additional users, a particular user for which the respective level of confidence is highest.

19. The non-transitory computer storage medium of claim 18, wherein identifying one or more additional users comprises identifying one or more additional users that were previously assigned the network address prior to the time at which the network event occurred.

20. The non-transitory computer storage medium of claim 15, wherein performing the action based on the level of confidence comprises:
determining that the level of confidence meets a threshold level of confidence; and
generating and transmitting data that identifies the user.
